(19) United States
(12) Patent Application Publication
(10) Pub. No.: US 2015/0159630 A1
(43) Pub. Date: Jun. 11, 2015

(54) WIND POWER GENERATION SYSTEM AND METHODS

(71) Applicant: Median Wind, LLC, Carlsbad, CA (US)

(72) Inventor: Roger L. Haskell, Carlsbad, CA (US)

(21) Appl. No.: 14/627,798

(22) Filed: Feb. 20, 2015

Related U.S. Application Data
(63) Continuation of application No. 13/108,766, filed on May 16, 2011, now abandoned.

(51) Int. Cl. F03D 9/00; H02K 7/18; F03D 3/00

(52) U.S. Cl. CPC F03D 9/002; F03D 3/005; H02K 7/183

(57) ABSTRACT

One embodiment of a system for receiving wind and converting it to storable power, includes a wind capturing apparatus, including a least three sails, the least three sails having a shape, oriented to have an axis of rotation perpendicular to a surface on which the system is positioned, wherein the wind capturing device captures induced wind; an axle, in communication with wind capturing apparatus such that it receives rotational energy when the wind capturing apparatus rotates about the axis of rotation; and a generating unit, the generating unit receiving rotational energy from the axle and transforming it into storable energy.

### CROSS-REFERENCE TO RELATED APPLICATIONS

This application is a continuation of U.S. patent application Ser. No. 13/108,766 filed May 16, 2011, which is a national stage application of PCT/US09/64626, filed on Nov. 16, 2009, which claims the benefit of U.S. Provisional Application No. 61/114,992, filed Nov. 14, 2008, all of which are incorporated by reference in their entirety.

### BACKGROUND

Wind power has become a viable source of clean and renewable energy, and it is growing at 30% per year. Unfortunately, it is limited to remote areas of the country that have very strong winds. Typically, wind power generators are extremely large and not easily deployed in a wide area.

Another problem with wind power is that the strength of area winds is not entirely predictable and there can be long lulls in the production of wind power that can put high demand on other segments of the power system. The lack of predictability of wind power and the inability to deploy it regardless of the geographical location makes some wind power solutions less than optimal.

### SUMMARY OF THE INVENTION

In one embodiment, a system for receiving wind and converting it to storable power, including: a means for capturing wind energy; an axle, in communication with the means for capturing wind energy; and a generating unit, the generating unit receiving rotational energy from the axle and transforming it into storable energy, wherein the generating unit is incased in a structure one which the system is mounted. Optionally, the storable energy is electricity. In one alternative, the system is located near a road system. Alternatively, the system is located on a median of a road, the median separating two lanes of the road. In another alternative, traffic on the two lanes of the road travel in different directions. Alternatively, the median has a width and the means for translating wind energy is not wider that the width of the median. In another alternative, the system includes a cage, oriented around the means for translating wind energy. In another alternative, an axis of rotation of the means for translating wind energy is perpendicular to a surface on which the system is positioned.

In another embodiment, a system for receiving wind and converting it to storable power, includes a wind capturing apparatus, including a least three sails, the least three sails having a shape, oriented to have an axis of rotation perpendicular to a surface on which the system is positioned, wherein the wind capturing device captures induced wind; an axle, in communication with wind capturing apparatus such that it receives rotational energy when the wind capturing apparatus rotates about the axis of rotation; and a generating unit, the generating unit receiving rotational energy from the axle and transforming it into storable energy. In one alternative, the shape is similar to a sail. In another alternative, the shape is an airfoil. In another alternative a lower camber of the airfoil is no more than zero. Alternatively, a lower camber of the airfoil is less than zero. Alternatively, the angle of attack is between 90 degrees to 45 degrees in relation to the surface on which the system is positioned. Optionally, an angle of attack is closer to 45 degrees at an edge of a leading edge further from the axis of rotation. Alternatively, the shape includes a first airfoil in a direction perpendicular to the axis of rotation and the shape resembles and a second airfoil in a direction parallel to the axis of rotation. In one alternative, a first lower camber of the first airfoil is no more than zero. Alternatively, a second lower camber of the second airfoil is no more than zero. In one alternative, the system further includes a median housing the generator unit, interconnected with the axle. In one alternative, the system further includes a power transmission line, interconnected with the generator unit, at least partial housed in the median. In one alternative, the system further includes a pressure fit system for holding the axle in the median to prevent wobble and allow for maintenance. In one alternative, the at least three sails are separated from the axis creating a Venturi passage that induces wind flow to each of the at least three sails. In another alternative, the wind capturing apparatus is designed to catch both horizontal and vertical flow resulting from a median along a roadway.

In one alternative, the system a median located on a roadway, the plurality of wind power generators positioned on the median, the median housing at least a portion of the plurality of transmission lines. In one alternative, each of the plurality of wind power generators is no wider than the median. Alternatively, the plurality of wind power generators is connected in series via the plurality of transmission lines. In one alternative, malfunction of one of the plurality of wind power generators does not affect a remaining plurality of wind power generators. In another alternative, the plurality of transmission lines is embedded in concrete. In another alternative, each of the plurality of wind power generators is removable without affecting the function of the rest of the system. In another alternative, each of the plurality of wind power generators has a safety cage. Optionally, each of the plurality of wind power generators is positioned on the tip of a median. In one alternative, each of the plurality of wind power generators has wattages in the range of 100-1000 watts. In one alternative, each of the plurality of wind power generators has wattages in the range of 100-500 watts. In one alternative, each of the plurality of wind power generators has wattage in the range of 300-400 watts. In one alternative, each of the plurality of wind power generators has wattage of 350 watts.

### DESCRIPTIONS OF THE FIGURES

FIG. 1 shows a perspective view of one embodiment of a wind power generation apparatus;

FIG. 2 shows a side view of wind power generation apparatus of FIG. 1;

FIG. 3 shows a top view of wind power generation apparatus of FIG. 1;

FIG. 4 shows a bottom view of wind power generation apparatus of FIG. 1;

FIG. 5 shows a perspective view of one embodiment of a sail for a wind power generation apparatus;

FIG. 6 shows a top view of the sail of FIG. 5;

FIG. 7 shows a side view of the sail of FIG. 5;

FIG. 8 shows a side view of the sail of FIG. 5;

FIG. 9 shows a bottom view of the sail of FIG. 5;

FIG. 10 shows a side view of an alternative embodiment of a wind power generation apparatus;

FIG. 11 shows a top view of the wind power generation apparatus of FIG. 10;

FIG. 12 shows a perspective view of one embodiment of a wind power generation apparatus;

FIG. 13 shows a top view of wind power generation apparatus of FIG. 12;

FIG. 14 shows a side view of wind power generation apparatus of FIG. 12;

FIG. 15 shows an exploded perspective view for an assembly for use with a wind power generation apparatus;

FIG. 16 shows an exploded perspective view for an assembly for supporting the sails of a wind power generation apparatus;

FIG. 17 shows a perspective view of the assembly of FIG. 16;

FIG. 18 shows a top view of one embodiment of a wind power generation installation;

FIG. 19 shows a side view of the wind power generation installation of FIG. 19;

FIG. 20 shows one embodiment of a schematic for a power substation; and

FIG. 21 shows another embodiment of a schematic for a power substation.

### DETAILED DESCRIPTION

1) System for Generating Wind Power

One embodiment of a system for generating wind power wind generator specifically designed to function atop roadway median barriers and atop barriers adjacent to roadways. While in alternatives, the angle of axis may be within a complete sphere or circle, in one embodiment a vertical axis shaft supports sails/blades which rotate around that axis. This axis, which is seated in bearings allowing for rotation, is captured at the base and captured at the top for support. The unique shape of a median barrier, which is designed to deflect vehicles back into their lane and direction of traffic, provides for a unique sail/blade design which best captures the forward moving and upward moving air displaced by vehicles. That shape is comprised of a sail which has curvature, as might be pictured in a traditional boat sail, thickness as in an airfoil, and a backward swept cupped shape as it reaches the top, not dissimilar from the curved palm of a hand. The sails/blades, which may be single or multiple, are composed of a durable material such as fiberglass or carbon fiber, and can be fabricated as independent units or a single multi-sailed unit. The extended sails base formed by the sail arms in diameter is no greater than the base width of the barrier to which it is mounted. In one embodiment the generator sail base diameter is ¾ the height of the generator sails. The air displaced by a moving vehicle causes the generator to rotate as a vehicle passes. Naturally occurring wind also causes the generator to rotate. The median barrier directs the air from vehicles passing in opposite directions, on opposite sides of the median barrier, to the wind generator, or more properly generators, as multiple units linked together along the spine of the barriers. The generators are wired together in parallel to allow for the collection of energy from multiple units.

One embodiment includes wind generator which is mounted atop a median barrier, and which utilizes the unique air flow patterns created by vehicles moving adjacent to that barrier to generate electricity, and which is unique in sail/blade design to utilize that unique air flow. One embodiment of a combined system includes a linked series of wind generators mounted atop a series of linked median barriers, or mounted atop a continuous median barrier, to form a joined source for collection of energy. These linked wind generators utilize the unique air flow patterns created by vehicles moving adjacent to that barrier to create electricity.

Embodiments of a system for generating wind power are an innovative new way to generate wind power in any geographic area, regardless of the prevailing wind conditions. Induced wind technology provides a mechanism to generate electricity from the untapped resource of vehicles moving on road systems. For example, the vertical axis wind turbine generators are secured atop roadway median barriers, and the air displaced by passing vehicles is caught by rotating sails to create electricity. The shape of the sails has been engineered to capture both forward moving and upward driven air that is present at the highway median barrier.

In one example turbines are about 2 feet tall—unobtrusive compared to the massive turbines typically found in commercial wind farms. When installed along the highway median barrier, they produce a tremendous amount of power: over 462,000 watts from just one mile of highway. One hundred miles of turbines highway generates 46 million watts of clean domestically-produced electricity.

Even when there is little or no traffic, the turbines can efficiently capture the natural wind. Local winds vary by location; for example Los Angeles gets 7.8 mph on average, and Honolulu has 10.6 mph winds. The worldwide average is 7 mph, but winds as low as 2 mph will start the turbine generators running—even in the absence of traffic-induced wind. In locations with strong ambient wind speeds, larger more powerful 5 kW turbines may be installed in the median area to capture additional power from the prevailing winds.

The design of one embodiment of the turbines was the result of extensive Computer Aided Design (CAD) research. Composed primarily from lightweight aluminum and composite fiber, it is one of the smallest and lightest vertical axis wind turbines in the world. Each turbine has three sails shaped to capture wind moving along the highway median barrier. This includes the typical horizontal air flow, but unlike conventional wind turbines, it is curved to catch air displaced by passing vehicles that moves up the face of the median barrier.

In one embodiment, each turbine drives a 350 watt curve-shifting generator, and the whole assembly is bolted into anchors set into the existing concrete median barrier. The generator itself fits inside a cored section of the concrete, blocking any noise it creates and preventing its exposure to any vehicle colliding with the median. Manufacturing is done with CNC machines to produce a highly uniform and well-balanced product with a minimum of component parts. In another embodiment each turbine drives a 100 watt or less generator. In another embodiment, each turbine drives a 400 watt or less generator. In another embodiment, each turbine drives a 1500 watt or less generator. In another embodiment, each turbine drives a 3000 watt or less generator. In another embodiment, each turbine drives a 5 kW or less generator. The generator selected for use may depend on the expected wind speed. In some embodiments, the wattage of the generators range from 100-400 watts. In some embodiments, the wattage of the generators range from 350-1000 watts.

Embodiments of the median mounted turbines have construction costs similar to conventional natural gas fired power plants but since the turbines do not require any fuel, they have a profound advantage in operational cost. The median mounted turbines compares even more favorably with carbon-neutral power plants such as nuclear. The cost estimate for new 2,308 megawatt nuclear power plant proposed in Florida is $14 billion. At just ¼ that cost, 500 miles of the median mounted turbine highway would produce the same amount of electricity—without the waste and accident risk. A complete and integrated system for harvesting wind power using low wattage generators has no previously been conceived, since at least in part, a effective and complete installation plan had not been contemplated. The induced wind harvesting system enables the systematic installation of varying wattage wind power generators on a mass scale in a complete power and infrastructure system. Furthermore, the infrastructure of the power transmission system disclosed herein, and the inverters, allows for a plurality of different wind generators have the same or disparate wattages, as well as other power sources to be integrated into a single system. Alternatively, the transmissions systems can serve to transfer, not only the power collected from energy sources, but all energy transfer needs.

Highway wind power can be generated in the very environment where most electricity is consumed: in and around our cities. This is a significant advantage over large wind farms, which exist in rural areas and require new infrastructure to transmit the electricity and have significant power loss with transmission distance. These collocated power generation facilities save on power transmission lines and can be integrated into power transmission systems.

Embodiments of the wind turbines generate approximately 350 watts when the highway wind averages 20 mph. One hundred miles of the median mounted turbine highway would produce enough electricity to power 500,000 homes.

In some embodiments each mile of highway will support 1,320 of the median mounted turbines and produce 4.6 megawatts (million watts) of pollution-free renewable electricity. One hundred miles of the median mounted turbine highway would produce as much electricity as a 500 megawatt combined cycle power plant—enough to power a major urban center like San Diego.

The median mounted turbines are not available for retail sale, but production costs average less than $1,000 each at scale. Each unit produces about $7 (wholesale cost) of electricity per day, so the units will pay for themselves in less than 30 months of operation. Since the turbines disclosed herein have been engineered to have a 10 year life expectancy, each one can go on to produce almost $20,000 of free electricity. Power resulting from the disclosed turbines and systems costs about ¼th as much to build as a nuclear power plant of equivalent size.

The median mounted turbines are self-starting and begin producing electricity in air speeds as low as 2 mph. Average highway wind speeds are 7-14 mph, but with traffic moving at 65 mph or higher, wind induced at the median barrier can be as high as 30 mph. Even without the benefit of induced wind from passing traffic, the world's average prevailing wind speed is 7 mph.

Vehicles accidentally contacting the median barrier should not travel high enough to impact embodiments of the turbine. Embodiments of extensive crash testing to ensure the turbines do not create a projectile threat when impacted by a vehicle that manages to climb the median barrier. Finally, electrical wires are shielded by steel plates and are designed to shear within the base and trip a fuse breaker so a hot wire would not be exposed in an accident.

Vertical-axis wind turbines are quieter than conventional “propeller” shaped wind turbines, and the disclosed turbines have been engineered specifically for low noise operation. Aerodynamic noise is low because the vertical-axis turbines have short arms, and mechanical noise is minimized because the generator components are insulated by the concrete barrier they are housed inside. Furthermore, the noisy highway median environment blankets any negligible noise the generators produce.

### a) Turbine Units

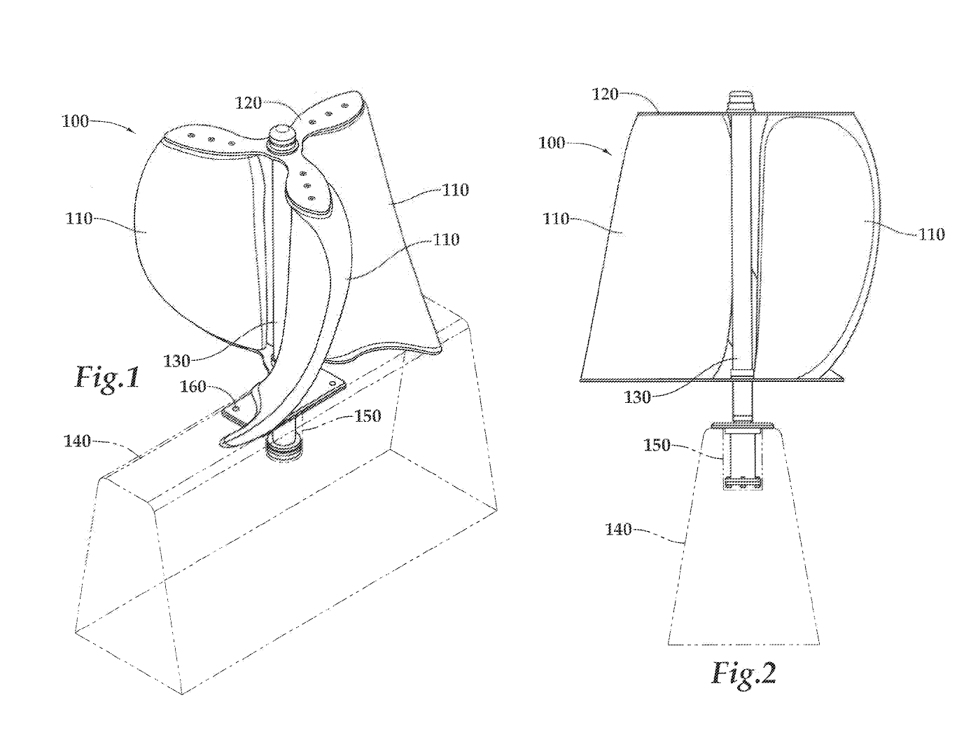

Turbine units (which may also be referred to as a wind power generation apparatus) generally must have a device to capture wind energy, an axle to transfer the energy, a generator that receives energy from the axle and converts the form of energy, and a mounting mechanism. One embodiment of a turbine is shown in different views in FIGS. 1-4. Turbine 100 includes three sails 110, an axle 130, a top sail brace 120 (which may also be referred to as an upper star), bottom sail brace 121 (which may also be referred to as a lower star), median 140, curve-shifting generator 150, and a base plate 160. Axle 130 runs perpendicular to the median that it is mounted on. Therefore, the plane of rotation of the sail assembly is parallel to the mounting surface, median 140. In various alternatives, the turbine includes more sails and different structural components. Furthermore, in alternatives, the turbine is sized to fit closely within the area occupied by the median on a roadway, and may be approximately 2 feet high and 1 foot in radius, however, the size may be adjusted according to wind conditions, the place mounted, and safety concerns.

i) Wings/Sails

The wings or sails of a turbine, for instance turbine 100, may take many different forms or shapes. The sail or wing structures and some of their supporting structure are referred to as a means for capturing wind energy. All of the embodiments disclosed herein and the embodiments that will be realized by those skilled in the art in light of this disclosure are considered means for capturing wind energy. In the embodiments of System for Generating Wind Power, wings or sails are oriented and designed to capture the most likely direction and force of the wind and are therefore designed to be bigger or smaller accordingly.

(1) Shape

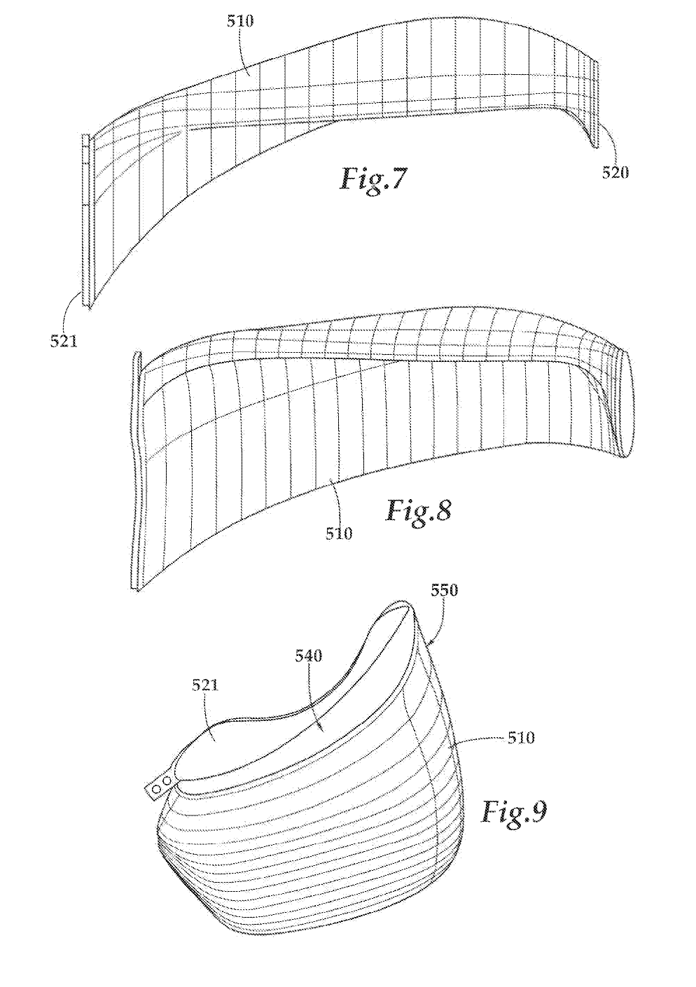

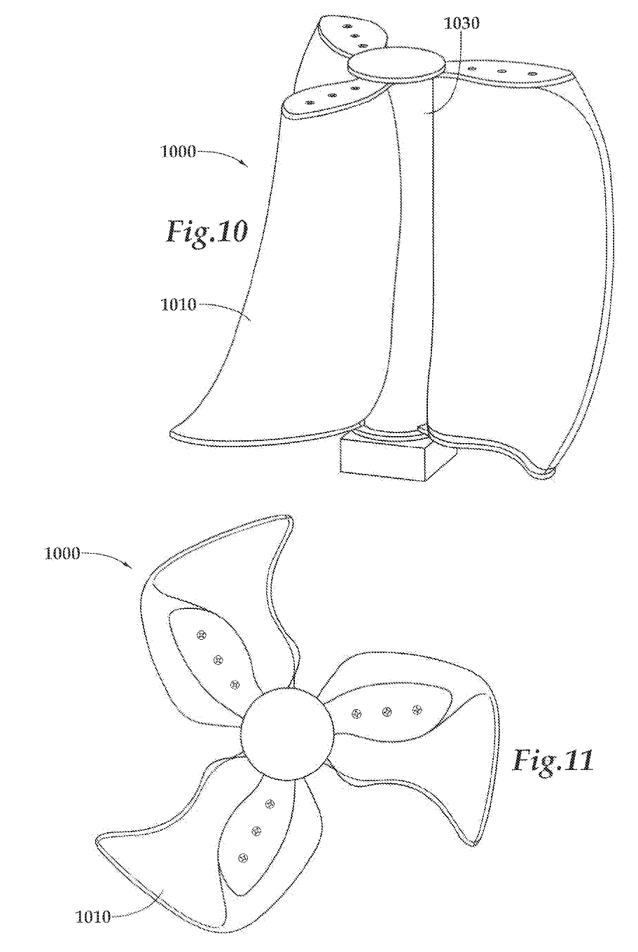

In one embodiment, the shape of the sails is designed to capture upward and horizontal air flow. This is because the air flow near medians on roadways tends to flow in these directions. As cars advance along the roadway they quickly displace air pushing air both forwards and upwards. The cars also push air to the side, however this flow is limited by the medians, which cause the airflow to be converted to have an upwards flow. In addition to the sails 110 show in FIGS. 1-4, more detailed views of the sails are shown in FIGS. 6-9 as well as an alternative embodiment shown in FIGS. 10-11.

As shown in FIGS. 1-11 the embodiments shown have a cupped shape. Referring to FIG. 5, sail 510 has an airfoil shape in both the horizontal and vertical directions. The sail includes bottom support 521 and top support 520. The leading edge of the air foil in for receiving horizontal wind force is leading edge 550. The trailing edge is trailing edge 560. In the vertical direction, the leading edge is leading edge 540 and the trailing edge is trailing edge 570. This is referred to as a dual airfoil design. Although the sails shown in FIGS. 1-11 have a dual air foil shape, in alternative embodiments the sails have no airfoil or a single airfoil.

Additional features of the airfoils of the sail 510 are the camber and the angle of attack is relation to the expected wind direction. In both the vertical and horizontal direction the camber is increased in the embodiments of FIGS. 1-11. This increase is decreased in order to prevent stalling of the turbine. As the turbine turns this allows for a wider allowable range of angles of attack between the flow of air and sail. In alternative embodiments, depending on the expected airflow, the camber may be increased, and the total profile reduced if expected wind is to be high velocity. The overall efficiency of the turbine is subservient to the need to generate some turn of the turbine in variable wind conditions.

In the embodiment of the turbine 1000 shown in FIGS. 10-11 varies from the embodiments show in FIGS. 1-9 in that the sails 1010 extend all the way to the center axle 1020. As shown, sail 1010 contacts axle 1030. This improves torque generation at the center of the turbine; however, the airfoil effect of the sails is reduced in comparison to the embodiment of FIGS. 1-9. This design (FIGS. 10-11) may be more effective in high constant wind areas. In contrast, the design in FIGS. 1-9 also provides acceleration of the wind due to the Venturi effect. As the air is funneled through the gaps between the sails 110 and the axle 130, the smaller aperture tends to accelerate the wind as it passes it to the next sail 110. In lower wind conditions, the acceleration through the Venturi effect may assist in breaking the static momentum of the turbine 100. By separating the sails from the roational axis a Venturi passage is created between the sail and the axis that that induces wind flow the neighboring sail.

The characteristics of the area that the turbines are mounted change the optimal characteristics for the turbines. As explained above, in areas of consistently high winds the size of the turbines may be increased, the shape of the turbines may be optimized by reducing the camber of the sails, and orientation and air foil designed to receive upward flow may be eliminated, since the vertical wind flow is insignificant as compared to the horizontal flow.

2) Study/analysis

Thorough computational flow analyses have been completed in order to optimize the performance characteristics of the turbine of FIGS. 1-9. To efficiently capture wind from passing vehicles, the induced wind technology takes advantage of the speed of the wind and the distinctive way it moves up and along the median barrier.

Multiple prototype models were considered before achieving the design of FIGS. 1-9. The advantages of its unique shape have been verified by sophisticated 3D flow analysis modeling. Full wind profiles from 4 different directions were tested to predict output, torque, side loads, and maximum wind speed with over 90% accuracy.

The median mounted turbines generators produce 350 watts from highway air passing at an average of 20 mph. It can withstand hurricane force winds in excess of 100 mph.

The purpose of the flow analysis was to give an understanding of the flow characteristics over the wind turbine design in order to provide additional insight into how the design alters the airflow path and affects power generation capabilities. Flow scenarios were chosen to give a better understanding of the torque generated and reaction forces on the structure when different wind patterns are applied. The flow analysis provides the ability to understand the flow patterns prior to developing and testing a full prototype. Computational flow analyses are best used for comparative studies and should be correlated with empirical testing.

The turbine depicted in FIGS. 1-4 was tested. A solid model was developed in the SolidWorks CAD software as shown in FIGS. 1-4. The model was scanned from a physical prototype and transferred into SolidWorks. The SolidWorks Flow Simulation software was used to perform 3-D flow analyses.

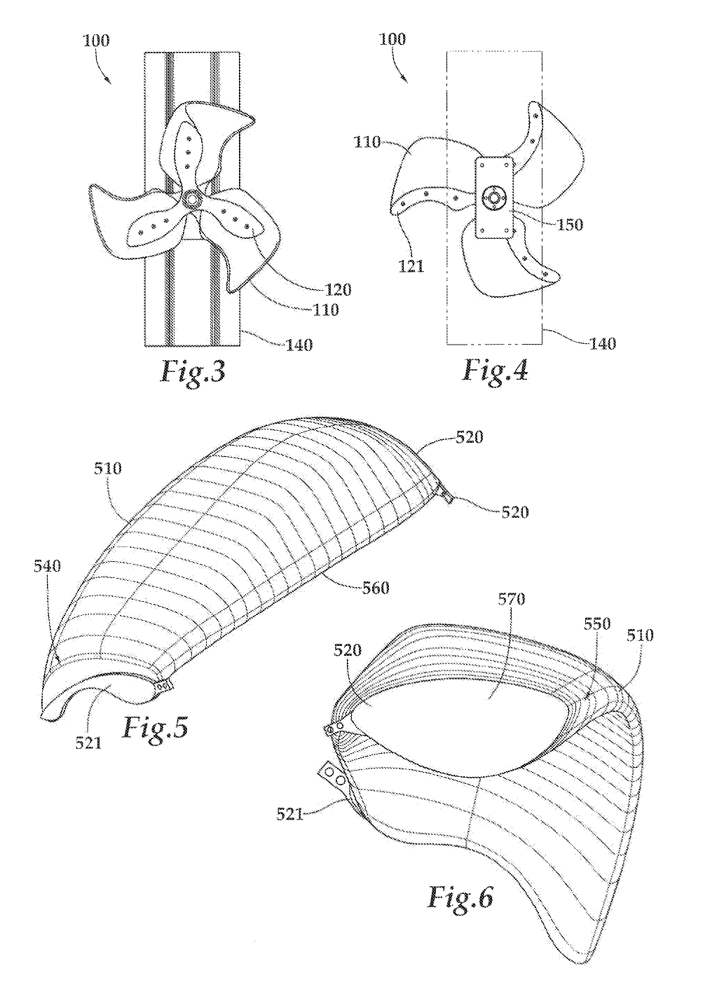

A wind speed of 10 mph was used as a baseline for many of the flow analyses in this report since this value as an average highway wind speed. Higher wind speeds are used in other studies which are discussed. The analysis assumes a static turbine position in order to determine the torque loading and reaction forces on the structure. Full wind profiles of 10 mph were applied individually in all 4 global directions in order to simulate different blade positions and crosswinds. Table 1 shows a summary of the results and FIGS. 3 through 6 show the flow patterns over the blades.

TABLE 1
Original Design—Flow Analysis with Varying Wind Directions

| | | | Force- | Force- | Force- | Resultant | |
|---|---|---|---|---|---|---|---|
| Wind | Direc- | Torque | X | Y | Z | Force | Power |
| Speed | tion | (N-m) | (lbs) | (lbs) | (lbs) | (lbs) | (W) |
| 10 | +X | 0.079 | 0.853 | −0.015 | 0.028 | 0.853 | 1.065 |
| 10 | −X | 0.245 | −0.728 | −0.045 | 0.188 | 0.752 | 3.311 |
| 10 | +Z | 0.286 | −0.334 | −0.021 | 0.695 | 0.772 | 3.875 |
| 10 | −Z | 0.099 | −0.305 | −0.020 | −0.796 | .0852 | 1.339 |

Power levels in the above table were calculated based upon the Torque applied to the structure. Actual power levels generated from the wind turbine is dependent upon the actual blade tip velocity ratio and the efficiency of the generator.

Flow characteristics were also determined at higher wind speeds to mimic hurricane conditions and to determine force loading used in the structure and bearing designs. As expected, power levels are proportional to the cubic power of the velocity levels. Table 2 shows the results of analysis with variable wind speeds.

TABLE 2
Original Design—Flow Analysis with Varying Wind Speeds

| | | | Force- | Force- | Force- | Resultant | |
|---|---|---|---|---|---|---|---|
| Wind | | Torque | X | Y | Z | Force | Power |
| Speed | Direction | (N-m) | (lbs) | (lbs) | (lbs) | (lbs) | (W) |
| 10 | −Z | 0.099 | −0.305 | −0.020 | −0.796 | 0.852 | 1.339 |
| 60 | −Z | 3.815 | −10.711 | −0.801 | −28.739 | 30.670 | 309.899 |
| 120 | −Z | 15.116 | −43.961 | −3.198 | −115.870 | 123.929 | 2455.687 |

Since highway winds may have a tendency to lift off the ground, uplift flow analysis was also performed to determine the effects of the rising wind. Wind at 10 mph was applied in the +Y direction. A 12 inch boundary strip along the X-axis at the base of the turbine did not have air velocity applied to it since wind flows upwards from the sides of the highway median structure only and not through the median. A 12 inch median boundary width at the support of the turbine was determined based upon Internet searches. Table 3 shows the results.

TABLE 3
Original Design—Uplift Flow Analysis

| | | | | | Resultant | |
|---|---|---|---|---|---|---|
| Wind | Torque | Force-X | Force-Y | Force-Z | Force | Power |
| Speed | (N-m) | (lbs) | (lbs) | (lbs) | (lbs) | (W) |
| 10 | −0.028 | 0.013 | 0.150 | −0.047 | 0.049 | −0.376 |

This analysis assumed a vertical wind speed of 10 mph at the base of structure. Torque and force levels are much lower than those seen with a horizontal wind speed of 10 mph. Also, vertical wind speeds are expected to be much lower than the horizontal wind speeds so the amount of relative torque from the vertical component of the wind is much lower than the horizontal component.

An additional flow studies were also performed to simulate wind flow being driven in opposite directions from both sides of the median. Wind was driven at 10 mph on both sides of the median at the outer radius of the wind turbine blades. This scenario was performed in the +Z/−Z direction. When wind is driven in opposite directions and at equal distances from the median, the centerline velocity at the median approaches zero since the driving forces eventually cancel each other out. The wind velocity exponentially decays as it gets closer to the center median causing very little torque on the turbine. Results are shown in the following Table 4.

TABLE 4
Original Design—Bi-Direction Flow Study

| | | | | | Resultant | |
|---|---|---|---|---|---|---|
| Wind | Torque | Force-X | Force-Y | Force-Z | Force | Power |
| Speed | (N-m) | (lbs) | (lbs) | (lbs) | (lbs) | (W) |
| 10 | 0.010 | −0.002 | −0.001 | −0.009 | 0.009 | 0.135 |

A more conservative approach to understanding flow being driven in opposite directions is to assume a vortex being generated at the centerline of the median with the circumferential velocities set at 10 mph. For example, when cars are driving at 10 mph in opposite directions immediately adjacent to the turbine, instead of air flowing in a straight line parallel to the median, a vortex is generated around the turbine with an outer circumferential velocity at 10 mph.

The turbine design was also analyzed with rotating flow conditions in order to further simulate the turbine being driven by a circular vortex. A rotating fluid control volume was generated to encompass the turbine model and an angular velocity of the air was applied. A baseline wind speed of 10 mph correlated to an angular velocity of 130 RPM assuming a tip speed ratio of 1. This condition correlates to 2 cars driving in opposite directions at 10 mph while generating a vortex right at the turbine. 260 RPM and 390 RPM conditions were also evaluated. Results are shown in Table 5. Since power levels are proportional to the cubic power of velocity, different baseline wind speeds and tip speed ratios can be used to extrapolate expected power levels.

TABLE 5
Original Design—Rotational Flow Analysis

| | Angular | | Force- | Force- | Force- | Resultant | |
|---|---|---|---|---|---|---|---|
| Wind | Velocity | Torque | X | Y | Z | Force | Power |
| Speed | (RPM) | (N-m) | (lbs) | (lbs) | (lbs) | (lbs) | (W) |
| 10 | 130 | 0.362 | 0.010 | −0.121 | 0.004 | 0.011 | 4.900 |
| 20 | 260 | 1.900 | 0.019 | −0.588 | 0.018 | 0.026 | 51.445 |
| 30 | 390 | 3.834 | 0.124 | −1.126 | 0.143 | 0.189 | 155.726 |

Analysis was also performed in relation to the design shown in FIGS. 10-11.

The horizontal flow analysis performed on the design of FIGS. 1-9 was repeated with respect to the design shown in FIGS. 10-11. Results are shown in the table and figures below. Air flow patterns and torque loading are significantly different than with the original design. Torque due to air flow in the +X and +Z direction are higher with the new design but torque due to air flow in the −X and −Z direction are much lower since the proposed design no longer has the “airfoil” effect of the sails. Higher forces on the structure are also seen with the new design since air flow can no longer pass between the sails causing drag forces to increase.

TABLE 6
Proposed Design—Flow Analysis with Varying Wind Directions

| | | | Force- | Force- | Force- | Resultant | |
|---|---|---|---|---|---|---|---|
| Wind | Direc- | Torque | X | Y | Z | Force | Power |
| Speed | tion | (N-m) | (lbs) | (lbs) | (lbs) | (lbs) | (W) |
| 10 | +X | 0.266 | −0.737 | −0.031 | 0.184 | 0.760 | 3.602 |
| 10 | −X | 0.069 | 1.027 | −0.018 | −0.105 | 1.032 | 0.936 |
| 10 | +Z | 0.312 | −0.467 | −0.034 | 0.784 | 0.912 | 4.231 |
| 10 | −Z | 0.001 | −0.508 | 0.028 | −0.827 | 0.970 | 0.009 |

Flow characteristics were also determined at higher wind speeds to mimic hurricane conditions and to develop design loads used for the structural and bearing designs. Resultant forces are much higher with the design shown in FIGS. 10-11 as compared to the design in FIGS. 1-9. However, the amount of torque generated is much less with the new design since the “airfoil” effect is no longer present with the 1 piece sail design.

TABLE 7
New Design—Flow Analysis with Varying Wind Speeds

| | | | Force- | Force- | Force- | Resultant | |
|---|---|---|---|---|---|---|---|
| Wind | Direc- | Torque | X | Y | Z | Force | Power |
| Speed | tion | (N-m) | (lbs) | (lbs) | (lbs) | (lbs) | (W) |
| 10 | −Z | 0.001 | −0.508 | 0.028 | −0.827 | 0.970 | 0.009 |
| 60 | −Z | −0.127 | −18.759 | 1.024 | −29.823 | 35.232 | 10.304 |
| 120 | −Z | −0.571 | −75.436 | 4.073 | −120.604 | 142.253 | 92.770 |

The design shown in FIGS. 10-11 was also analyzed with rotating flow conditions. A rotating fluid control volume was generated to encompass the turbine model and an angular velocity of the fluid was applied. A baseline wind speed of 10 mph correlated to an angular velocity of 130 RPM assuming a tip speed ratio of 1. 260 RPM and 390 RPM conditions were also evaluated. Results are shown in Table 7. Since power levels are proportional to the cubic power of velocity, different baseline wind speeds and tip speed ratios can be used to extrapolate expected power levels.

TABLE 8
Proposed Design—Rotational Flow Analysis

| | | | | | Resultant | |
|---|---|---|---|---|---|---|
| Wind | Torque | Force-X | Force-Y | Force-Z | Force | Power |
| Speed | (N-m) | (lbs) | (lbs) | (lbs) | (lbs) | (W) |
| 130 | 0.500 | 0.014 | −0.099 | 0.014 | 0.019 | 6.774 |
| 260 | 1.523 | 0.067 | −0.490 | 0.018 | 0.070 | 41.228 |
| 390 | 2.201 | 0.002 | −0.685 | 0.049 | 0.049 | 89.403 |

The design of FIGS. 1-9 showed an “airfoil” effect with the individual sails which helped redirect the air flow to the other blades and increase the torque applied to the generator. The one piece design of FIGS. 10-11 showed higher torques in certain blade orientations but much lower torques in other orientations which may lead to stalled conditions. The higher drag was mainly caused by the elimination of the gap between the main axis and sails. In an alternative where the 1-piece proposed design is used, external flow vanes should be considered to ensure that sufficient torque is applied to the generator and to avoid a stalled condition.

iii) Cage

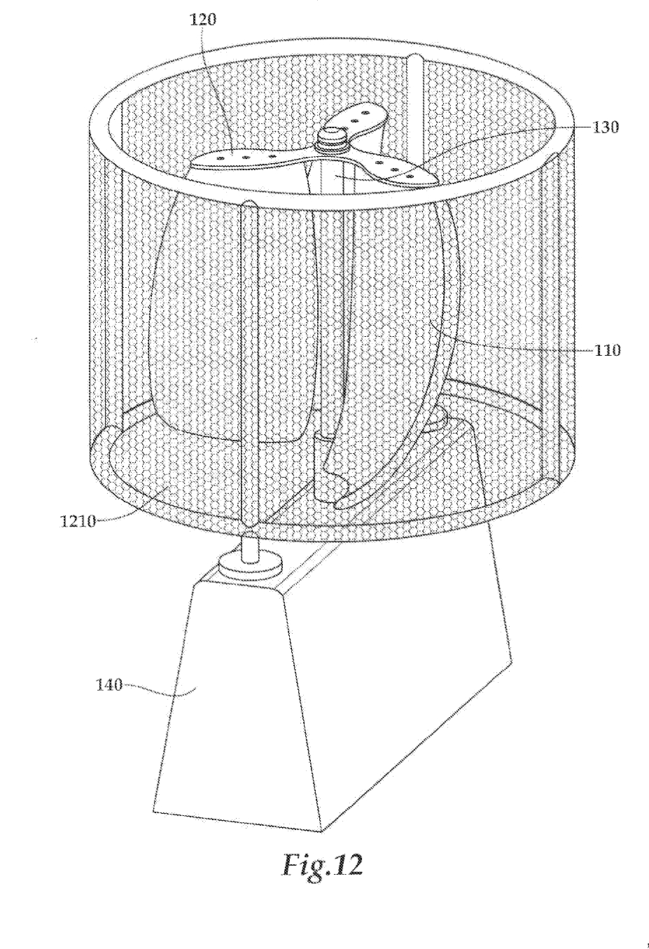

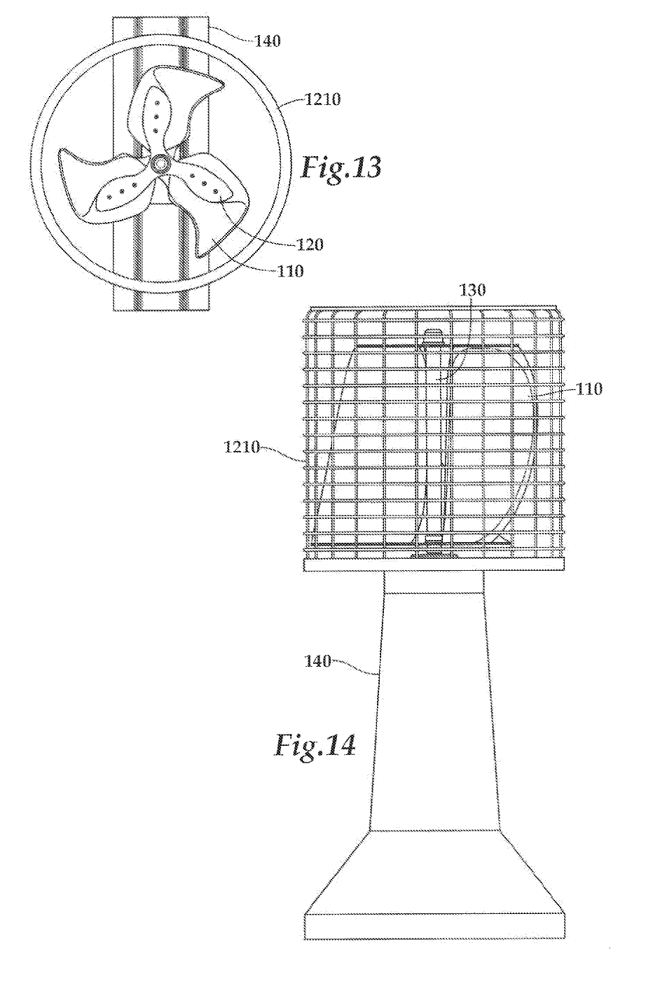

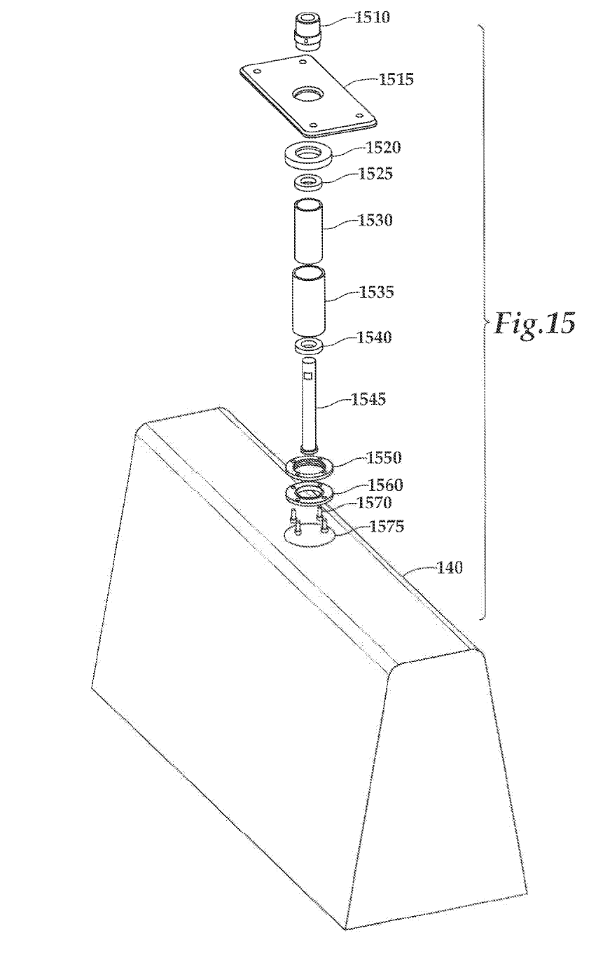

Some embodiments of the turbine units may also include a safety cage as shown in FIGS. 12-14. In these embodiments the turbine 100 includes a safety cage 1210. The safety cage 1210 is constructed out of 1 inch PVC tubing. The tubes are cut to length and heated to 100 C. The tubes are then bent around a wooden form. The tubes are glued to each fitting and then a screw is used to pin each connection joint. The screens were cut to shape and zip tied to the outer tubular fame work. The screens in the embodiments shown are made out of molded mesh and have a Diamond Opening Size of 0.68″×0.68″. The PVC conduits used are approximately 1″ thick.

The safety cage 120 prevents birds and debris from contacting the turbine 100. Further, it provides an added safety feature in case of accident.

iv) Median Installation

As explained above, there are numerous considerations for mounting the turbines on medians or in other locations.

(1) Sizing

The sizing of the turbines is a consideration for installation of the system. When used in a roadway setting, visibility obstruction, space, and wind strength are considerations. When mounted on a median, the width of the turbines is limited to approximately the width of the medians themselves. The height is therefore generally restricted to a height of approximately 2 feet in order to not obscure vision. Furthermore, sizing is related to the expected wind velocities in an area. High expected wind velocities can support larger turbines. Therefore, although the turbine embodiments shown in FIGS. 1-4 are designed for the width of the median, to a height of approximately 2 feet, and for the expected wind conditions of a typical highway, variations in the size of the turbines will occur to those skilled in the art in light of this disclosure.

(2) Fit to a Support Structure and Sail Support

FIGS. 15-17 show the mounting mechanism for one embodiment on a median structure and the support structure for the sails. Referring to FIG. 15, an embodiment of the generator and support structure are mounted in a median or other support structure. The assembly includes shaft adapter 1510 which connects to the axle of a wind turbine such as axle 130 shown in FIG. 1. Plate 1515 screws or bolt down over the receptacle 1575 in the median 140 housing the generation system in order to provide protection to the generation system and stability.

The generator system includes generator face 1520, and bearing 1525, which in this embodiment is a ball bearing system, however other friction reducing systems may be used. The generation system includes a bearing spacer 1530, a housing cover 1535, and an additional lower set of bearings 1540. The generator shaft 1545 is head securely, but is able to freely turn due to bearing 1525, 1540, flange 1550 and bearing retainer 1560. Bolts 1570 or other holding device hold the system together.

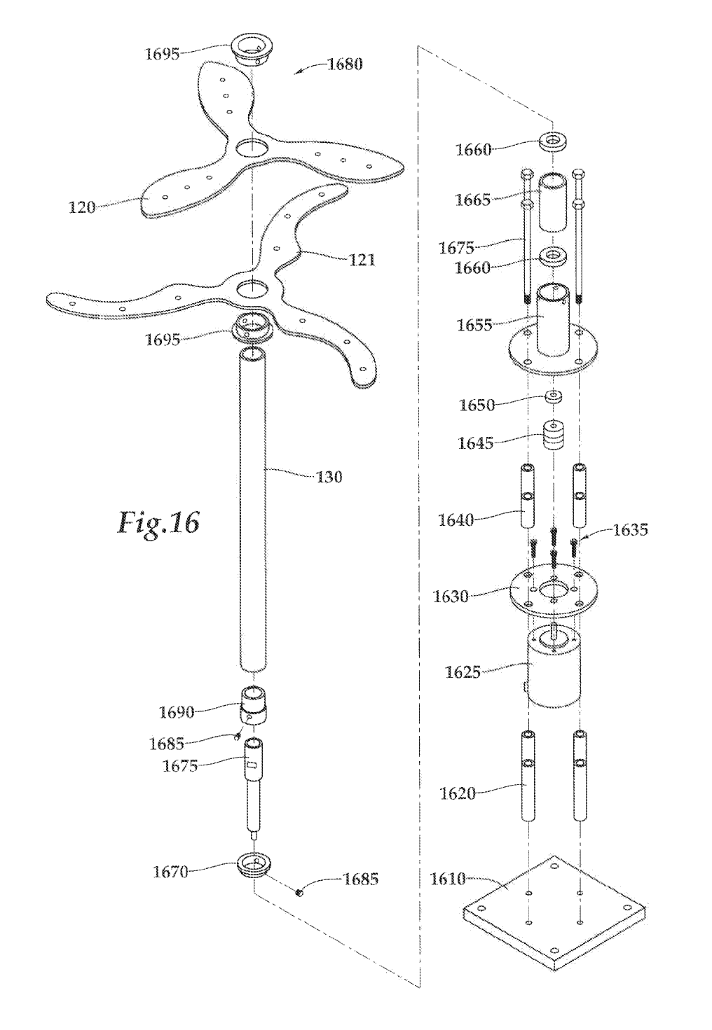

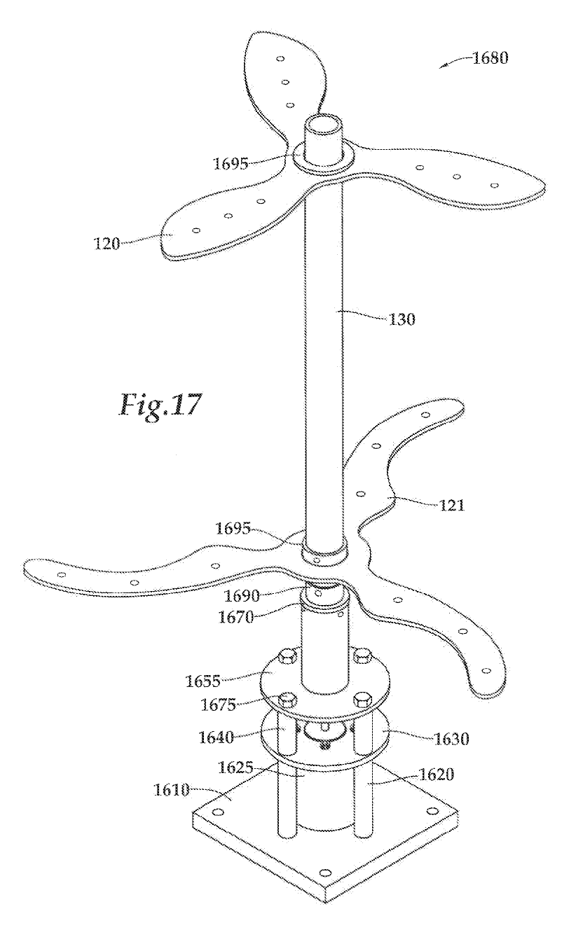

FIG. 16 shows one embodiment of an exploded view of the support structure for the sails and generator and FIG. 17 shows a perspective view of the completed structure. Table 9 identifies the parts of the support structure 1680.

TABLE 9
Parts of Support Structure

| Part | | | | | |
|---|---|---|---|---|---|
| No. | QTY. | PART NUMBER | DESCRIPTION | MATERIAL | FINISH |
| 1610 | 1 | Plate, Base | Plate, Base | Aluminum | None |
| 1620 | 4 | Rod, Spacer | Rod, Spacer, Long | Aluminum | None |
| 1625 | 1 | Generator, | Generator, | | None |
| | | Experimental, | Experimental | | |
| | | Version 2 | | | |
| 1630 | 1 | Plate, Generator | Plate, Generator | Aluminum | None |
| | | Mounting | Mounting | | |
| 1645 | 1 | Shaft Coupling | Shaft Coupling | | None |
| 1640 | 4 | Rod, Spacer | Rod, Spacer, Short | Aluminum | None |
| 1655 | 1 | Housing, Bearing | Housing, Bearing | Tube: 1½ | Black Oxide |
| | | | | Schedule 40 | |
| | | | | Pipe; Plate: | |
| | | | | Steel, A36 | |
| 1660 | 2 | Bearing, Ball | Bearing, Ball | | None |
| 1670 | 1 | Collar, Bearing | Collar, Bearing | Aluminum | None |
| | | Retainer | Retainer | | |
| 1675 | 1 | Shaft, Bearing | Shaft, Bearing | Steel, Type | Black Oxide |
| | | | | 1010, 1018 OR | |
| | | | | A36 | |
| 1665 | 1 | Sleeve, Bearing | Sleeve, Bearing | Aluminum | None |
| | | Spacer | Spacer | | |
| 130 | 1 | Shaft | Shaft | Steel Tubing, | Black Oxide |
| | | | | Type 1010, | |
| | | | | 1012 or 1018 | |
| 1690 | 1 | Adapter, Shafter | Adapter, Shaft | Steel Bar | Black Oxide |
| 121 | 1 | Lower Star, Test | Lower Star, Test | Aluminum, | None |
| | | Model | Model | 6061-T6 | |
| 1695 | 2 | Hub | Hub | Aluminum, | None |
| | | | | 6061-T6 | |
| 120 | 1 | Upper Star, Test | Upper Star, Test | Aluminum | None |
| | | Model | Model | 6061-T6 | |
| 1650 | 1 | Spacer | Spacer | Aluminum | None |
| 1685 | 11 | SSCUPSKT 0.25- | Set Screw, ¼- | Steel | Black Oxide |
| | | 20 × 0.3125-HX-N | 20 × .312 | | |
| 1635 | 4 | HX-SHCS 0.164- | Socket Head Cap | Steel | Zinc Plated |
| | | 32 × 0.375 × 0.375-N | Screw, 8-32 × .375 | | |
| 1675 | 4 | HBOLT 0.3750- | Hex Bolt, ⅜- | Steel | Zinc Plated |
| | | 16 × 7.5 × 1-N | 16 × 7.5 | | |

The support structure 1680 fits into a support structure such as a median. The system is similar to that shown in FIG. 15.

Although not shown in FIGS. 15-17, (also see FIG. 19 for one embodiment of a view of the wiring system), a wiring system extends from the base of the generator structure to transfer power to the desired target. Further, in some embodiments shims may be included to ensure a snug pressure fit of the support structures. Such shims and pressure fitting reduce wobble of the attached turbine. Since wobble reduces the efficiency of the turbines and increases the wear on the support structure, such as the median, effective use of shims is utilized in some embodiments.

v) Customized Medians

In the embodiments shown in FIGS. 1-4 and 15, a standard median 140 is used to support the turbine wind generation system. In some embodiments, a customized median is included, with preformed or cut airs for the mounting of the generator, turbine, and transmission wires. Since medians are typically formed from cement, the cutting process may lead to irregular receptacles for the turbine and generation systems, or structural weakness in the medians. By performing medians with the proper receptacles, the structural integrity of the median is maintained, while easing installation of the turbines and generators. In some alternatives, the custom formed medians include additional rebar reinforcement around the turbine attachment point to increase wear duration and reduce wobble of the turbine by providing a solid support structure.

b) Power Transmission and Complete Installation

The embodiments of the turbines described in FIGS. 1-17 are specially designed for a complete roadside installation. Alternative, turbines could be used in a complete median installation, and there are advantages implemented in the complete system that function regardless of the turbine used.

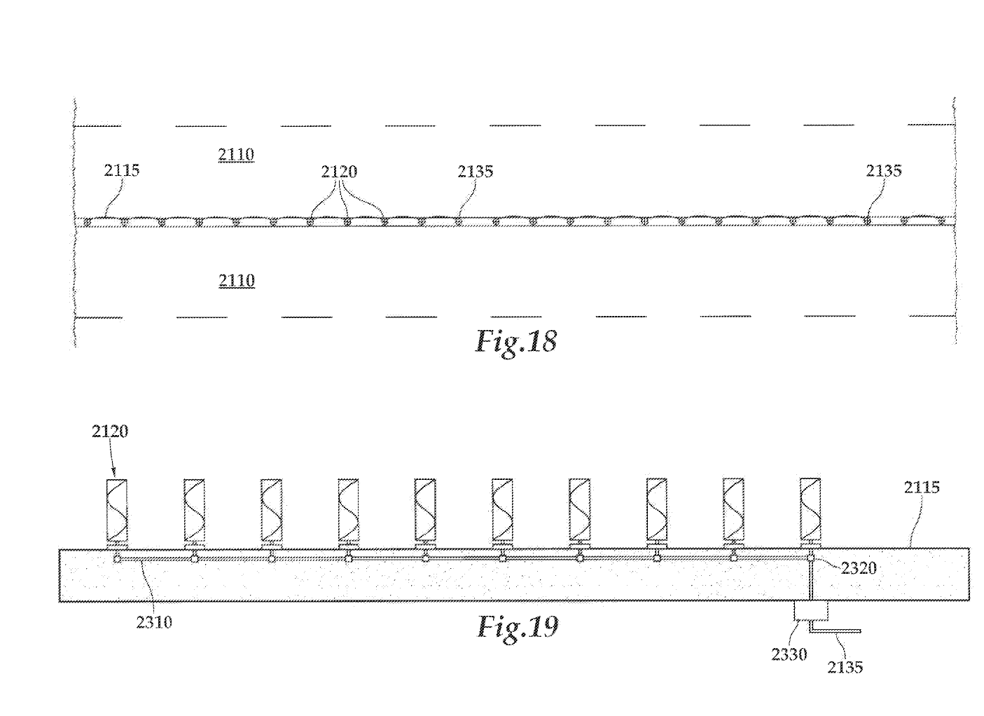

The embodiment of the complete installation and power system shown in FIGS. 18-21 includes the turbines embodied in FIGS. 1-4. The complete installation is entirely modular, making installation and repair easy. Turbines 100 are installed on top of existing concrete median barriers every 4 feet. They are wired together in parallel, and their power is sent to substations located every mile or as needed. These substations form a smart grid with monitoring and switching functions to deliver power from the system to those communities along the highway that need it most.

Installation of the embodiment shown is expected to be 100 miles in length and projected to take 3 years to complete. But because of the modular nature of the system, power is generated incrementally as it is built from the first mile forward. Each mile of highway contains 1,320 units and produce 462,000 watts of additional clean power.

Because of this “plug and play” nature, a damaged or malfunctioning turbine 100 can be replaced on the highway median in as little as 30 minutes. The new unit is simply bolted in place and tied to the local junction box. And since power generation from other turbines is not affected, the replacement can be done when traffic flow is low.

As turbines are installed along a stretch of highway, their connections form the backbone of a new high-voltage transmission system. A smart grid is essential infrastructure for integration of alternative energy from all sources, but the present embodiment serves as a smart grid while generating additional new electricity at the same time.

Unlike large conventional and nuclear power plants, power is not subject to catastrophic accidents and by virtue of its being spread out makes it less likely as a terrorist target. Because power generation is so broadly distributed, no single event could damage more than a small fraction of the system.

As our energy demands continue to increase, highway wind generation systems can be installed on additional highways. This provides both new generation capacity as well as the new transmission capacity required for any new power source. It can be extended by as little as one mile or as much as needed—the length of our highway system is virtually unlimited.

Wind turbines are linked into a smart grid with high-voltage transmission lines embedded in the highway median. This would replace the need for overhead lines that can be a landscape eyesore and has on rare occasion even been the source of devastating wildfires.

A smart grid replaces our antiquated national electricity network with modern technologies that can adapt to changing supply and demand. It increases reliability, reduces costs, and can help save energy. Without a smart grid, new sources of alternative energy cannot be added. There simply isn't enough transmission capacity in the current grid, and the challenges of unpredictable energy production from alternative energy sources require the intelligent controls of a smart grid. The disclosed turbines are linked to together along the highway system; they provide new high voltage transmission lines that connect our cities and states together. Complete highway system is installed in locations around the country seeking new sources of clean power, and they will eventually meet to connect distant power sources and consumers together.

As shown in FIG. 18 turbines 2120 are installed on median 2115 on roadway 2110. Turbines 2120 are positioned every 4 feet. Every 11 turbines 2120 are connected in parallel and then transferred to an equipment compound at transfer points 2135. The cross section shown in FIG. 19 shows the electrical system embedded in the median 2115. A conduit 2310 connects the turbines 2120 in parallel. Under every turbine 2120 is an electrical junction 2320. An underground junction 2330 transfers power through conduit 2135 to a combiner.

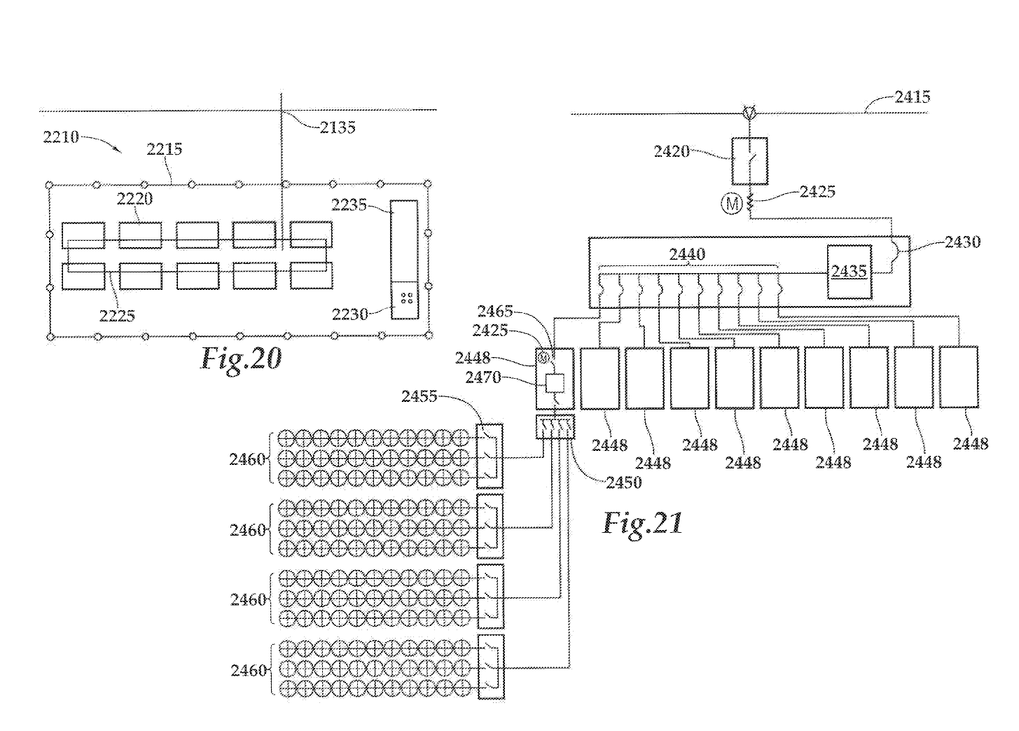

FIG. 20 shows an electrical substation, 2210. This substation receives input from sets of turbines 2120 through conduit 2135. The substation 2210 includes a perimeter fence 2215, inverters 2220, a duct trench 2225 for cooling, a performance monitor 2235, and a transmission line 2230 to the main electrical grid. Power received from the wind generation units is provided as direct current and may be converted to alternating current in order to be input into the main power grid. The electrical substation can alternatively receive inputs from a variety of power generation devices and is not limited to receiving power from the turbines. In this way, such a substation can support a host of power creation devices.

The disclosed design model for a 100 mile system of wind turbines allows for integration with existing power grid systems and conversion to new “smart grid” systems as they are developed and defined.

Delivery of generated power is through utilization of power inverters and sub-stations, installed in parallel, in 1 mile increments. The inverters are sized to accommodate peak production of the connected turbines. The sub-stations are the interconnecting component from the 1 mile section of turbines to the 100 mile system. The 100 mile system consists of an underground raceway with “distribution” conductors (rated at 132 kv or lower). The conductors carry the electricity generated from the turbine system. Available space for other utilities (communications, transmission, etc) is included in the 100 mile raceway. The 100 mile system can be interconnected to existing utility services at any point (or multiple points) along the 100 mile system. Delivery voltages vary according to the demographic.

In the current design, each 1 mile section is equipped with data gathering equipment to meet current codes and to accommodate monitoring requirement of the controlling entity. The following information is available via the listed equipment:

Data Logger/Monitor

AC Power Monitoring

Production Monitoring.

Peak Production Tracking.

DC Production Monitoring.

Real-time data at 15-minute intervals.

Daily, Weekly and Monthly overviews.

Local data storage.

Data Warehousing.

Web-based presentation of Historical and Real-time.

Energy Data in graphs and tables.

Performance Alarming via email and cell phone

Wind Speeds in Real-time

Wind Speed history

Weather conditions in Real-time

Performance Meter

Per code and utility requirement, the performance meter gathers peak performance and cumulative power contributions to the utility grid.

FIG. 21 shows another embodiment of a system connecting the turbines to an electrical grid. Electrical line 2415 is a line from the existing power grid or smart grid. A safety switch 2420 connects the power generation system to the power grid. The safety switch 2420 is sized according to the grid voltage. A performance meter 2425 monitors output to the grid as described above. A main switch 2430, sized according to the grid voltage, connects the substation 2435. A breaker 2440, in this case a 6000 AMP, 480V, 3PH Bus-100KAIC braced, services to connect and interrupt power flow as needed. Each inverter system 2448 converts received direct current to alternating current and transmits to the breaker 2440. The inverter system 2448 includes a 500 KW inverter 2470, a performance monitor 2425, and line 2465 for transferring the power on. Feeding each inverter system 2448 is a 1600 AMP, 4 pole combiner 2450, which receives power from 4 sets of turbines. Each set of 33 turbines 2460 feeds to a series combiner 2455 and then to 4 pole combiner 2450.

One embodiment of an electrical installation for a 100 mile model includes many features. Although, turbines on medians and the associated collection and distribution systems may be installed near any road system, in one embodiment locations used include open highways without bridges. This budgeting and design model assumes that the roadway includes at a minimum, one mile sections of uninterrupted median. This median may include turn around points for emergency vehicles however. Each 1 mile section requires approximately 13 miles of conduit and wire to complete and assumes existing utility transmission systems (minimum 12 KV) are located and accessible within ¼mile of the installation location. Smart grid system may enhance connectivity and allow for fractionalization of interconnection. Tin one alternative, the wind generators are wired in series and installed in strings of 11, with the voltage for any series will not exceed 600 VDC. Power from the Wind Generators is “transformed” to usable power through inverters and a sub-station located near the area of install (exact location will be determined by the relevant administrative bodies). Power production levels is recorded and remotely monitored from each inverter. Routing and circuit management is facilitated through fused combiner boxes (both at the median and adjacent to the inverter equipment). Power performance (volume being put on the grid) is metered at the highest voltage in the system (after the substation, before the utility Point of Connection).

Although the disclosed systems and methods are described in terms of mounting turbines on medians by roadways, such wind power systems may be implemented in a variety of similar contexts where wind power may be harvested. For instance, similar systems may be implemented near train routes, in tunnels, subways, etc. Train routes share the advantage that roadways provide, in that the flow of trains is predictable and regular, and therefore well suited to be harvested. Furthermore, turbines and subsystems need to be installed in concrete medians. Any suitable housing that can support the generator, wiring, and turbine may be used.

Although the present wind power generation systems and methods have been described with reference to specific embodiments, this description is not meant to be construed in a limited sense. Various modifications of the disclosed embodiments, as well as alternative embodiments of the present wind power generation systems and methods will become apparent to persons skilled in the art upon the reference to the description of the present wind power generation systems and methods.

1-36. (canceled)

37. A system for receiving wind and converting it to storable power, the system comprising:
(a) a wind capturing apparatus, including at least three sails, the at least three sails having a shape, oriented to having an axis of rotation perpendicular to a surface on which the system is positioned, wherein the wind capturing device captures induced wind;
(b) an axle, in communication with the wind capturing apparatus, such that it receives rotational energy when the wind capturing apparatus rotates about the axis of rotation; and
(c) a generating unit, the generating unit receiving rotational energy from the axle and transforming it into storable energy; wherein a lower cross-section of the airfoil has a first camber of less than zero and an upper cross-section of the airfoil has a second camber of greater than zero.
